(19) United States
(12) Patent Application Publication
(10) Pub. No.: US 2006/0081597 A1
(43) Pub. Date: Apr. 20, 2006

(54) Method for controlling a cooking process, and cooking appliance

(75) Inventor: Ramona Haberkamm, Traunreut (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/546,789

(22) PCT Filed: Mar. 11, 2004
(86) PCT No.: PCT/EP04/02546

§ 371 Date: Aug. 24, 2005

(30) Foreign Application Priority Data
Mar. 26, 2003 (DE) 103 13 595.2

(51) Int. Cl. F27D 19/00

(52) U.S. Cl. 219/412

(57) ABSTRACT

The invention relates to a method for controlling a cooking process in a closed cooking compartment (3) of a cooking appliance (1), especially a grilling appliance, provided with a heating device (5). The temperature in the cooking compartment (3) is set, and the heating device (5) is switched on and off in a temperature regulating cycle once a pre-determined switching temperature has been reached. The aim of the invention is to improve the browning process and especially to increase the radiation time of the heating device. To this end, during the cooking process, the temperature is reduced over the course of a temporary cooling-down phase and is increased again over a subsequent heating-up phase.

The invention relates to a method for controlling a cooking process and to a cooking device of the type explained in the preambles of claims 1 and 6.

Cooking devices in the form of cookers or the like are known in large numbers. The cooking process in these cooking devices is usually controlled by the user selecting manually either a certain cooking temperature or a certain pre-determined operating mode (and optionally an operating time) to which a certain cooking temperature is automatically allocated. When this cooking temperature is reached, the cooking temperature is then substantially held constant within a temperature regulating cycle, the heating device being switched on and off when a pre-determined temperature is reached in each case, wherein the temperature usually oscillates within a temperature range.

In shorter operating modes, such as the “grilling” operating mode, however there is the problem that the browning of the food is frequently unsatisfactory. In these shorter operating modes the degree of browning of the food depends on the time during which the food is exposed to direct thermal irradiation by the switched-on heating device. In the pre-heating phase the heating device is switched on continuously so that the food is continuously exposed to thermal radiation and thus browns well. During the regulating cycle however, the heating device is switched off cyclically so that the food is exposed to thermal convection in addition to the browning thermal radiation, as a result of which the food is browned less well. This is particularly noticeable when the food needs to be turned in the course of the cooking process, where the first side is then well-browned but the second side is rather cooked and less well browned.

It is the object of the invention to provide a method and a cooking device which provides a better browning result.

The invention is solved by a method according to claim 1 and a cooking device according to claim 6.

The proposal according to the invention to reduce the temperature over the course of a temporary cooling-down phase during the cooking process has the effect that the heating device then remains switched on for a longer time so that the food is exposed to the browning thermal radiation for a longer time.

Advantageous further developments of the invention can be deduced from the dependent claims.

It is particularly appropriate if the temporary cooling-down phase is initiated by switching off the heating device when the door of the cooking compartment is opened. This measure has an additional safety effect since on the one hand, it protects the user for example from excessive thermal radiation when turning the food and on the other hand prevents the heating device from remaining switched on if the door is unintentionally left open.

An exemplary embodiment of the invention is explained in detail hereinafter with reference to the drawings. In the figures:

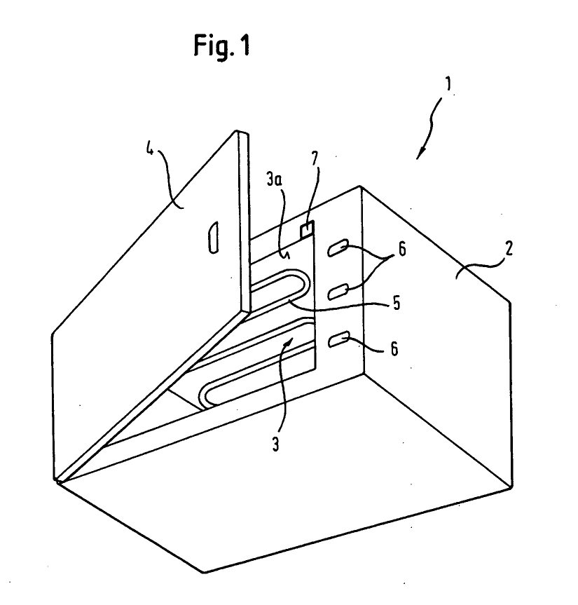

FIG. 1 is a schematic diagram of a cooking device according to the invention and

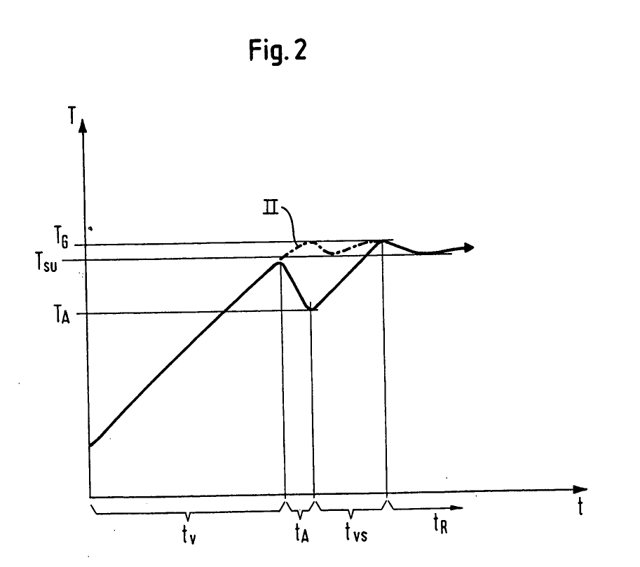

FIG. 2 is a schematic temperature-time curve of an exemplary cooking process.

FIG. 1 shows a cooking device 1 according to the invention which is shown as a grilling device in the present exemplary embodiment. The cooking device contains a housing 2 which surrounds a cooking compartment 3 which is closed by a door 4. Provided in the cooking compartment 3 is a usual heating device 5 in the form of a heating coil which is arranged on the ceiling 3a of the cooking compartment 3. Also provided are the usual temperature sensors, preferably in the rear area of the cooking compartment 3 which are not shown in the drawing.

The cooking device 1 further contains a control system not shown which can be actuated by conventional control elements 6.

Connected to the control system is a switching contact 7, which is only shown schematically and which actuates the opening and closing of the door. The switching contact 7 is embodied so that it switches off the heating device 5 as soon as the door 4 is opened and releases the switching on of the heating device 5 as soon as the door 4 is closed.

A cooking process will be explained in detail with reference to the temperature-time curve in FIG. 2. FIG. 2 shows the profile of a grilling process as a preferred cooking process. The user places the food for grilling in the cooking compartment 3 and selects the desired operating mode “grilling” and/or the desired cooking temperature and/or the desired cooking time by means of the control elements 6. After the door 4 is closed, the heating device is switched on and heats the cooking compartment 3 for the time t_{V}. During this time t_{V}, the heating device 5 stays switched on; the side of the food facing the heating device is thus exposed to permanent thermal radiation and consequently browns sufficiently. At the same time, the food pre-cooks. After the time t_{V} has elapsed, the food must be turned. The user opens the door 4 whereby the heating device 5 is switched off by the switching contact 7. As a result, the cooking compartment 3 is not heated further and the temperature drops to a reduced temperature T_{A} in the course of a temporary cooling phase t_{A}. If the door 4 is closed again after turning the food, switching on the heating device 5 is released again by means of the switching contact 7 so that the heating to the pre-determined food temperature T_{G} is continued in the time interval t_{VS} with substantially the same curve gradient as in the range t_{V}. In this way, the beginning of a regulating cycle t_{R} in which the heating device 5 is switched on and off in a clocked fashion to keep the temperature constant between the cooking temperature T_{G} and a lower switching temperature T_{SU}, is delayed. After turning the food, the second side of the food is thus exposed to the thermal radiation for a longer time than would be the case without the temporary cooling-down phase t_{A} and the food is browned better on the second side than would be the case with the usual change between the thermal radiation and thermal convection with the usual length of the regulating cycle t_{R}. The cooling-down phase t_{A} thus brings about a lengthening of the switching-on time of the heating device after the cooling. Without the cooling-down phase t_{A} on the other hand, the heating-up phase would not be interrupted or would substantially not be interrupted but would continue with the same angle of gradient as far as the cooking temperature T_{G} and would then go over into the regulating phase as is indicated by the dot-dash profile II in FIG. 2.

It should be pointed out that the heating device 5 is designed as relatively powerful especially for grill devices and the temperature sensors are usually so remote from the door that they cannot be influenced by the user so that opening the door 4 for turning the food with the heating device 5 continuing to run brings about a slight lowering of the temperature but this lowering is not sufficient to significantly increase the switching-on time of the heating device after turning and thus positively influence the degree of browning.

It is important for the efficiency of the invention that the temperature within the temporary cooling-down phase t_{A} is reduced to a reduced temperature T_{A} which is lower than the lower switching temperature T_{SU}. On the other hand, the temporal arrangement of the temporary cooling-down phase t_{A} can be applied to any point on the curve, i.e., it can be introduced for example only in the regulating cycle t_{R} and interrupt this.

The following table shows the effect of lengthening the cooling-down phase on the radiation time during the grilling of a steak.

| | | Grilling | |
|---|---|---|---|
| | | steaks | Grilling |
| | | without door | steaks with |
| | Duration | contact | door contact |
| First side | 10 minutes | Heater on for | Heater on for |
| | | 10 minutes | 10 minutes |
| Turning: | about 30 | Heater is | Heater off |
| | seconds | still on | |
| Second side | 5 minutes | Heater on for | Heater on for |
| | | 2 minutes | 3 min 40 sec |
| | | Heater off | Heater off |
| | | for 3 minutes | for 1 min 10 |
| | | | sec |

In a modification of the exemplary embodiment shown it is further possible to incorporate the temporary cooling-down phase in a cooking program, for example, by stopping the heating device from being switched on again after the temperature has fallen below the lower switching temperature, after first reaching the cooking temperature until the temperature has fallen sufficiently far below the lower switching temperature or has been actively lowered so that an extended radiation time of the heating device is then required.

The invention is preferably applied to grilling appliances or grilling devices but can be used wherever good browning with short cooking times and/or a safety function (by coupling with the door opening) is important.

1-8. (canceled)

9. A method for controlling a cooking process in a closed cooking compartment of a cooking appliance, especially a grilling appliance, comprising:
a heating device for heating the cooking compartment;
the temperature in said cooking compartment is set to a desired heating temperature (TG) for the food in a cooking process;
said heating device is switched on and off in a temperature regulating cycle once a pre-determined switching temperature has been reached in said cooking compartment during said cooking process;
the temperature during said cooking process is then reduced over the course of a temporary cooling-down phase (tA) in said cooking compartment; and
the temperature during said cooking process then is increased again during a subsequent heating-up phase (tVS) in said cooking compartment.

10. The method according to claim 9, including said temporary cooling-down phase (tA) is brought about by an unscheduled switch-off of said heating device relative to said regulating cycle.

11. The method according to claim 10, including said heating device is switched off when opening said cooking compartment.

12. The method according to claim 9, including said temporary cooling-down phase (tA) is introduced shortly before reaching said cooking temperature (TG).

13. The method according to claim 9, including said temporary cooling-down phase (tA) is introduced when said food is turned.

14. The method according to claim 13, including said heating device is switched off when opening said cooking compartment to turn said food introducing said temporary cooling-down phase (tA).

15. A cooking device, especially a grilling device, comprising:
a cooking compartment;
said cooking compartment including a heating device;
said cooking compartment being accessible via a door provided on said cooking compartment;
a control device having a temperature sensor coupled to said cooking compartment to regulate the temperature in said cooking compartment; and
a device for reducing said temperature during the course of a temporary cooling-down phase (tA).

16. The device according to claim 15, including said device for reducing the temperature contains a switching device for switching off said heating device.

17. The device according to claim 16, including said device for reducing the temperature includes said door and a switching contact engageable and activated by said door in at least one of an open or a closed position.

18. The device according to claim 17, including said switching contact is engageable and activated by said door at least in said closed position and said switching contact turns off said heating device when said door is opened.
